(19) United States
(12) Patent Application Publication
(10) Pub. No.: US 2025/0377169 A1
(43) Pub. Date: Dec. 11, 2025

(54) HEAT PIPE AND HEAT EXCHANGER INCORPORATING TRIPLY PERIODIC MINIMAL SURFACE STRUCTURES

(71) Applicant: WEI-HSIANG LAI, TAINAN CITY (TW)

(72) Inventors: WEI-HSIANG LAI, TAINAN CITY (TW); ABDUL SAMAD, TAINAN CITY (TW)

(21) Appl. No.: 19/057,124

(22) Filed: Feb. 19, 2025

(30) Foreign Application Priority Data
Jun. 6, 2024 (TW) 113121063

(51) Int. Cl. F28D 15/04; B33Y 80/00

(52) U.S. Cl. CPC F28D 15/046; B33Y 80/00

(57) ABSTRACT

A heat pipe includes a pipe body that includes a pipe interior space enveloped by a tubular wall and two end walls. A working fluid is filled in the pipe interior space. A wick structure is attached to inner surfaces of the tubular wall and the end walls. The wick structure is a TPMS structure and surrounds an innermost space within the pipe interior space. The wick structure allows the working fluid to circulate through a capillary action. In another embodiment, a heat exchanger includes first exchange channels and second exchange channels interposed between the first exchange channels. The heat exchanger incorporates a plurality of the heat pipes for use as the first exchange channels.

### CROSS-REFERENCE TO RELATED APPLICATION

This application claims priority to Taiwanese Invention Patent Application No. 113121063, filed on Jun. 6, 2024, and incorporated by reference herein in its entirety.

### FIELD

The disclosure relates to a heat pipe, and more particularly to a heat pipe and a heat exchanger incorporating triply periodic minimal surface structures.

### BACKGROUND

Heat exchangers are essential elements for conducting heat exchange. Heat exchangers transfers heat from a hot fluid medium to a cooler fluid medium, thereby promoting thermal circulation to maintain optimum operating temperature of a working equipment. In recent years technology has advanced swiftly and thermal energy actuators or generators have improved markedly in terms of power and efficiency, causing consumers to demand heat exchangers with improved characteristics such as being lighter, taking up less space, having better heat transfer efficiency, and having higher heat exchanging rate etc.

A conventional gyroid heat pipe incorporates a gyroid structure as its wick structure. This design enhances heat transfer efficiency and opens up the possibility to design heat pipes with tailored geometrics such as that of the gyroid structure.

The advantages of gyroid heat pipes encompass enhanced transfer efficiency, customizable geometries, thermal stability, capillary action, versatility, increased surface area, and lower thermal resistance, making them a compelling choice in diverse thermal management scenarios.

Gyroid heat pipes exhibit significant potential for implementation in electronics, automobile, and aerospace industries, offering a compelling combination of lightweight design, customizable geometry, and efficient thermal management capabilities. Their inherent adaptability to complex spatial constraints aligns well with the stringent weight considerations in aerospace applications, while the unique gyroid structure enhances heat transfer efficiency. This technology proves particularly valuable for electronic systems cooling, ensuring optimal performance and longevity in the face of extreme temperature variations. Additionally, gyroid heat pipes contribute to energy efficiency and offer resilience to mechanical stresses and vibrations, making them well suited for deployment in spacecraft thermal control systems. Their adaptability to harsh environments, including vacuum conditions and extreme temperatures, further positions gyroid heat pipes as a promising solution for addressing the diverse thermal challenges encountered in various industries.

### SUMMARY

Therefore, an object of the disclosure is to provide a novel heat pipe incorporating triply periodic minimal surface structures, and a novel heat exchanger that incorporates the novel heat pipe.

According to an aspect of the disclosure, the heat pipe includes a pipe body, a working fluid and a wick structure. The pipe body includes a tubular wall surrounding a pipe interior space, and two end walls respectively connected to two opposite ends of the tubular wall. The tubular wall and the end walls envelops the pipe interior space. The working fluid is filled in the pipe interior space. The wick structure is attached to inner surfaces of the tubular wall and the end walls inside the pipe interior space. The wick structure is a triply periodic minimal surface (TPMS) structure, is bonded to the inner surfaces, and surrounds an innermost space within the pipe interior space. The wick structure allows the working fluid to circulate through a capillary action from the innermost space to the inner surfaces of the tubular wall and the end walls and vice versa.

According to another aspect of the disclosure, the heat exchanger includes a heat exchanger body that includes a first side, a second side, a plurality of first exchange channels, and a plurality of second exchange channels. The first exchange channels extends from the first side to the second side and are spaced apart from each other. The second exchange channels are interposed between the first exchange channels. Each of the second exchange channels define a flow path extending from the first side to the second side, and has two opposite ends that respectively open at the first and second sides for communication with an external fluid. Each of the first exchange channels has a pipe body which includes a tubular wall that surrounds a pipe interior space, and two end walls that are respectively connected to two opposite ends of the tubular wall and that are respectively disposed at the first and second sides of the heat exchange body. The tubular wall and the end walls envelop the pipe interior space. Each of the first exchange channels further has a wick structure that is bonded to inner surfaces of the tubular wall and the end walls inside the pipe interior space and that surrounds an innermost space within the pipe interior space.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an embodiment of a heat pipe according to the present disclosure.

FIG. 2 is a longitudinally cross-sectioned fragmentary enlarged view showing structure of the embodiment of the heat pipe.

FIG. 3 is a fragmentary perspective and schematic view illustrating a gyroid structure of the embodiment of the heat pipe.

FIG. 4 is a transversely cross-sectioned view of the embodiment of the heat pipe.

FIG. 5A illustrates one example of an embodiment of a heat exchanger according to the present disclosure, with heat pipes of first exchange channels being uncut.

FIG. 5B is a longitudinally cross-sectioned view illustrating the embodiment of the heat exchanger of FIG. 5A.

FIG. 5C is a fragmentary enlarged view showing a portion of the embodiment of the heat exchanger of FIG. 5B.

FIG. 5D is a transversely cross-sectioned view illustrating the embodiment of FIG. 5A.

FIG. 6A illustrates another example of the embodiment of the heat exchanger according to the present disclosure.

FIG. 6B is a fragmentary enlarged view illustrating a portion of a gyroid structure of the embodiment of FIG. 6A.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

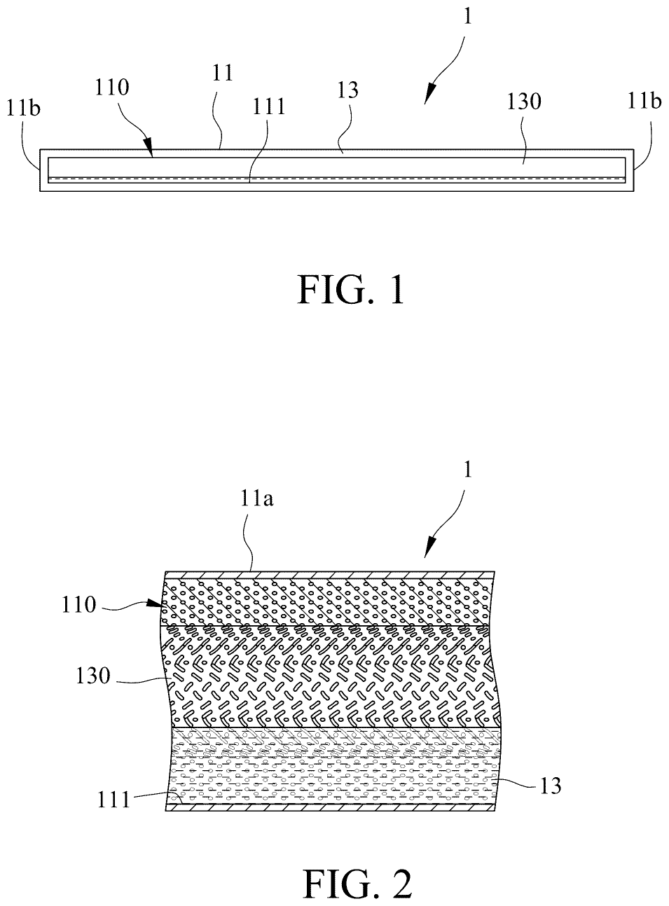

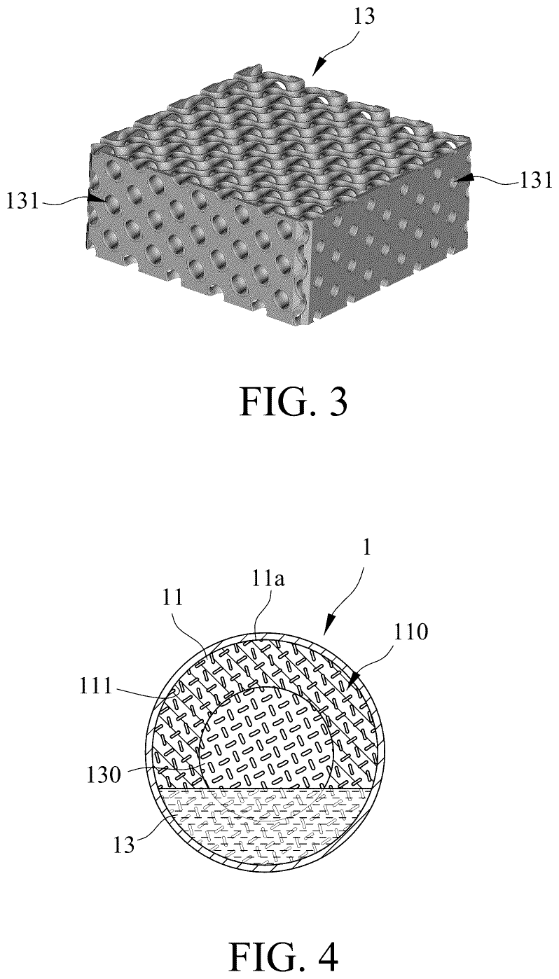

Referring to FIGS. 1 and 2, a first embodiment of a heat pipe 1 according to the present disclosure includes a pipe body 11, a working fluid, and a wick structure 13. The pipe body includes a tubular wall 11a surrounding a pipe interior space 110, and two end walls respectively connected to two opposite ends of the tubular wall 11a. The tubular wall 11a and the end walls 11b envelope the pipe interior space 110. The working fluid is filled in the pipe interior space 110. The wick structure 13 is attached to inner surfaces 111 of both of the tubular wall 11a and the end walls 11b inside the pipe interior space 110. In this embodiment, the pipe body 11 and the wick structure 13 are made from the same material. More specifically, the pipe body 11 and the wick structure 13 are made of a copper material; however, the disclosure is not thus limited. The working fluid may be selected according to the working temperature range of the heat pipe 1. For example, the working fluid may be purified water, ethanol, acetone or methane. If the heat pipe 1 is expected to function at a higher temperature range the working fluid may be mercury, cesium, lithium, or indium. In some embodiments, the pipe body 11 may be a standard heat pipe, a loop heat pipe, or a variable conductance heat pipe.

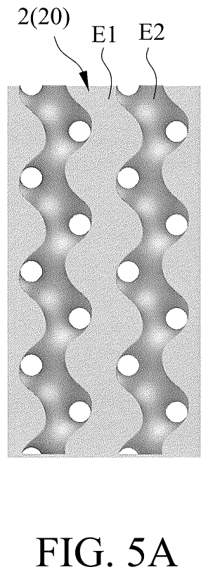

The wick structure 13 is a triply periodic minimal surface (TPMS) structure, is bonded to the inner surfaces 111, and surrounds an inner most hollow space smaller in cross section than the pipe interior space 110. The TPMS structure of the wick structure 13 is selected from one of a gyroid, a Schwarz primitive, a diamond, a Lidinoid, and a split-P. In this embodiment, the TPMS structure is a gyroid as shown in FIG. 3. It should be noted that standard fabrication techniques such as molding or machining are unable to produce TPMS structures. Therefore, in this embodiment, the heat pipe body 11 and the wick structure 13 are integrally formed in one piece via 3D printing. In some embodiments, the wick structure 13 may be a sintered powder wick structure, a grooved wick structure, or a sintered and grooved composite wick structure.

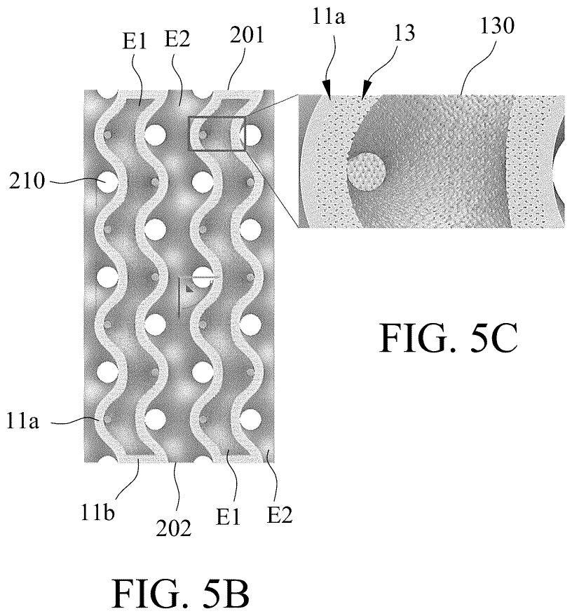

Referring to FIGS. 2 to 4, the wick structure 13 surrounds an innermost space 130 within the pipe interior space 110. The wick structure 13 has two fluid flow systems 131 that allow the working fluid to circulate through a capillary action from the innermost space 130 to the inner surfaces 111 of the tubular wall 11a and the end walls 11b and vice versa.

In an implication of the embodiment, the heat pipe 1 is set up to extend vertically or obliquely in a top-bottom direction on a heat generating electronic component, where an upper portion of the heat pipe 1 is a colder part of the heat pipe 1, and a lower portion of the heat pipe is a hot part of the heat pipe as it is heated by the heat generating electronic component. The working fluid in the hot part of the heat pipe 1 undergoes phase transition to a vapor which flows upward. When the vapor reaches the colder part of the heat pipe, it condenses and flows back to the lower hot part of the heat pipe by capillary action through the wick structure 13. This allows the heat pipe 1 to quickly and efficiently exchange heat.

Because the TPMS structure is a bio-inspired structure with high structural strength that is also made directly into the tubular wall 11a, it may tolerate higher working pressures compared to conventional heat pipes, the tubular walls 11a of the pipe body 11 may be thinner which may lower its thermal resistance. Additionally, because the TPMS structure denotes a periodic infinite structure with three independent orientations and a surface with zero mean curvature, the wick structure 13 may have more surface area for heat exchange, and create conditions for the working fluid to produce a turbulent flow which prevents boundary layer flow formation that decreases heat transfer coefficient as a flow length increases. Therefore, the heat pipe 1 according to the present disclosure may have a higher heat transfer coefficient. In an example of this embodiment, the tubular wall 11a and the end walls 11b of the pipe body 11 are impermeable and are not a TPMS structure. In other examples, all of the tubular wall 11a, the end walls 11b and the wick structure 13 are formed by a TPMS structure.

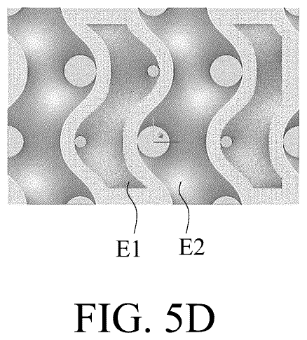

Referring to FIGS. 5A, 5B, 5C and 5D, an embodiment of a heat exchanger 2 according to the present disclosure includes a heat exchange body 20. The heat exchanger 2 may be a heat sink device. The heat exchange body 20 includes a first side 201, a second side 202, a plurality of first exchange channels (E1) each extending from the first side 201 to the second side 202 and spaced apart from each other, and a plurality of second heat exchange channels (E2). The second exchange channels (E2) are interposed between the first exchange channels (E1). Each of the second exchange channels (E2) defines a flow path extending from the first side 201 to the second side 202, and has two opposite ends that respectively open at the first and second sides 201, 202 for fluid communication with the external environment. Each of the first exchange channels (E1) has a similar structure as the heat pipe 1 of the embodiment shown in FIG. 1, and includes a pipe body 11 which includes a tubular wall 11a that surrounds a pipe interior space 110, and two end walls 11b that are respectively connected to two opposite ends of the tubular wall 11a and that are respectively disposed at the first and second sides 201, 202 of the heat exchanger body 20. The tubular wall 11a and the end walls 11b envelop the pipe interior space 110. Each of the first exchange channels (E1) further has a wick structure 13 that is bonded to inner surfaces of the tubular wall 11a and the end walls 11b inside the pipe interior space 110 and that surrounds an innermost space 130 within the pipe interior space 110. The first and second exchange channels (E1, E2) are integrally formed in one piece via 3D printing. The wick structure 13 may be selected from one a gyroid, a Schwarz primitive, a diamond, a Lidnoid, and a split-P.

The first and second exchange channels (E1, E2) are made of the same material. In an example, the first and second exchange channels (E1, E2) are made from a copper material. Each of the first and second exchange channels (E1, E2) is formed in a wavy pattern that extends from the first and second sides 201, 202. The whole structure of the heat exchange body 20 is a TPMS structure fabricated by a 3D printing. More specifically, for each of the first exchange channels (E1), the tubular wall 11a and the wick structure 13 are formed by a TPMS structure, i.e., a gyroid structure, as best shown in FIG. 5C. The tubular wall 11a is impermeable and separates the pipe interior space 110 of the pipe body 11 of from the flow path of an adjacent one of the second exchange channels (E2). There are a plurality of connecting holes 210 that fluidly communicate the second exchange channels (E2) with each other. By virtue of the heat exchanger body 20 having the connecting holes 210, an external fluid, such as air, water or other fluids may flow into and out of the second exchange channels (E2) for additional heat exchange which may enhance the heat transfer capabilities of the heat exchanger 2.

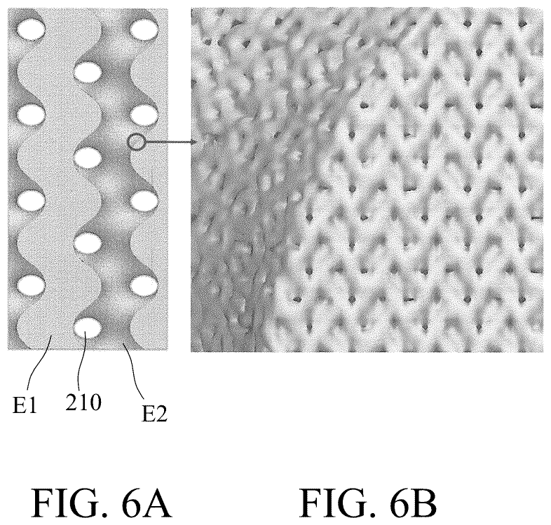

Referring to FIGS. 6A and 6B, a portion of a gyroid structure of another example of the embodiment of the heat exchanger is shown.

In summary of the above, in the heat pipe 1 and the heat exchanger 2 of the present disclosure, by virtue of the wick structure 13 being the TPMS structure that provides high structural strength, high contact surface area, and having specific curvature profiles, the heat exchanger 2 and the heat pipe 1 may have improved heat exchange performance compared to conventional heat pipes and heat exchangers.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A heat pipe comprising:
a pipe body that includes a tubular wall surrounding a pipe interior space, and two end walls respectively connected two opposite ends of said tubular wall, said tubular wall and said end walls enveloping said pipe interior space;
a working fluid that is filled in said pipe interior space; and
a wick structure attached to inner surfaces of said tubular wall, and said end walls inside said pipe interior space;
wherein said wick structure is a triply periodic minimal surface (TPMS) structure, is bonded to said inner surfaces, and surrounds an innermost space within said pipe interior space, said wick structure allowing said working fluid to circulate through a capillary action from said innermost space to said inner surfaces of said tubular wall and vice versa.

2. The heat pipe as claimed in claim 1, wherein:
said TPMS structure of said wick structure is selected from one of a gyroid, a Schwarz primitive, a diamond, a Lidinoid, and a split-P.

3. The heat pipe as claimed in claim 1 wherein said pipe body and said wick structure are made from a same material.

4. The heat pipe as claimed in claim 3, wherein said pipe body and said wick structure are integrally formed in one piece via 3D printing.

5. The heat pipe as claimed in claim 3, wherein said pipe body and said wick structure are made from a copper material.

6. A heat exchanger comprising:
a heat exchange body that includes a first side, a second side, a plurality of first exchange channels extending from said first side to said second side and spaced apart from each other, and a plurality of second heat exchange channels, wherein:
said second exchange channels are interposed between said first exchange channels, each of said second exchange channels defines a flow path extending from said first side to said second side, and has two opposite ends that respectively open at said first and second sides for fluid communication with an external environment;
each of said first exchange channels has a pipe body which includes a tubular wall that surrounds a pipe interior space, and two end walls that are respectively connected to two opposite ends of said tubular wall and that are respectively disposed at said first and second sides of said heat exchange body, said tubular wall and said end walls enveloping said pipe interior space; and
each of said first exchange channels further has a wick structure that is bonded to inner surfaces of said tubular wall and said end walls inside said pipe interior space and that surrounds an innermost space within said pipe interior space.

7. The heat exchanger as claimed in claim 6, wherein said wick structure is selected from one of a gyroid, a Schwarz primitive, a diamond, a Lidinoid, and a split-P.

8. The heat exchanger as claimed in claim 6, wherein said first and second exchange channels are made from a same material.

9. The heat exchanger as claimed in claim 8, wherein said first and second exchange channels are integrally formed in one piece via 3D printing.

10. The heat exchanger as claimed in claim 9, wherein said first and second exchange channels are made from a copper material.

11. The heat exchanger as claimed in claim 9, wherein each of said first and second exchange channels are formed in a wavy pattern from said first and second sides.

12. The heat exchanger as claimed in claim 9, wherein a whole structure said heat exchange body is a TPMS structure.

13. The heat exchanger as claimed in 12, wherein, in each of said first exchange channels, said tubular wall of said pipe body and said wick structure are formed by a TPMS structure that separates said pipe interior space from said flow path of an adjacent one of said second exchange channels.

14. The heat pipe as claimed in claim 1 wherein said wick structure is a sintered powder wick structure, a grooved wick structure, or a sintered and grooved composite wick structure.

15. The heat pipe as claimed in claim 1 wherein said pipe body is a standard heat pipe, a loop heat pipe, or a variable conductance heat pipe.
